(19) United States
(12) Patent Application Publication
(10) Pub. No.: US 2006/0198916 A1
(43) Pub. Date: Sep. 7, 2006

(54) Method for producing ceramic objects

(76) Inventors: Alexander Ralph Beeck, Orlando, FL (US); Boris Bublath, Berlin (DE); Nikolai-Alexander Daus, Berlin (DE); Dirk Goldschmidt, Moers (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/551,740

(22) PCT Filed: Apr. 1, 2004
(86) PCT No.: PCT/US04/10176

§ 371 Date: Sep. 30, 2005

Related U.S. Application Data
(60) Provisional application No. 60/460,326, filed on Apr. 4, 2003.

(51) Int. Cl. B28B 7/00

(52) U.S. Cl. 425/174.4

(57) ABSTRACT

A process for forming a ceramic object using selective laser sintering of ceramic powder is provided. The chemical composition and size distribution of the powder may be varied between various regions of the object, and the temperature achieved by laser heating may be varied between regions to achieve the desired degree of densification. In one embodiment, a ceramic mold (1) is formed in to have an envelope portion (4) and a core portion (7) with differing properties using a fast prototyping laser sintering process.

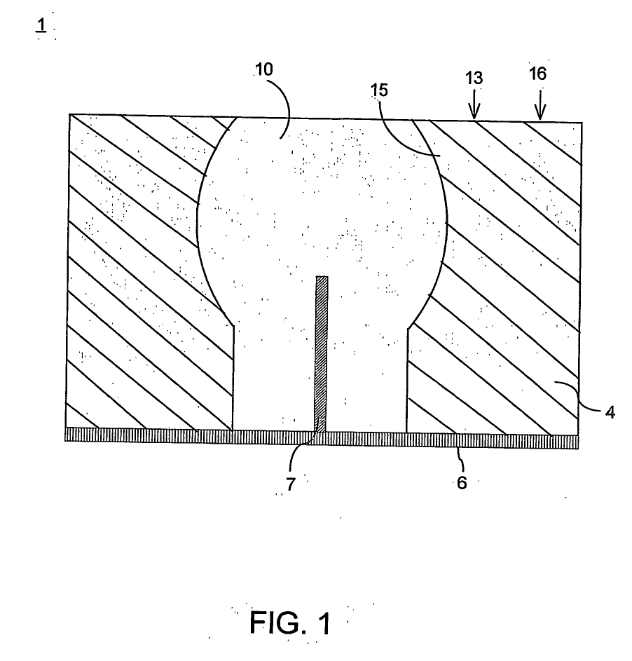

### CROSS REFERENCE TO RELATED APPLICATION

This application is the US National Stage of International Application No. PCT/US2004/010176, filed Apr. 01, 2004 and claims the benefit thereof. The International Application claims the benefits of U.S. Provisional Application No. 60/460,326, filed Apr. 4, 2003, both of the applications are incorporated by reference herein in their entirety.

### FIELD OF THE INVENTION

This invention relates to a process for producing ceramic objects, such as ceramic components and ceramic molds, from a ceramic powder.

### BACKGROUND OF THE INVENTION

For various purposes, e.g., test purposes, ceramic shaped objects often have to be produced quickly. Hitherto, complex processes have been used, such as the pressing of ceramic powders with subsequent sintering and machining to a final shape. Ceramic objects of this type may comprise, inter alia, mold shells which are used in casting. In this case too, it is desirable to produce mold shells quickly to allow rapid testing of castings, for example.

U.S. Pat. No. 6,446,697 has disclosed a process for producing complex castings in which wax models are used in an intermediate step.

U.S. Pat. No. 6,273,326 has disclosed the production of ceramic shaped parts in which individual layers are joined to one another by means of laser sintering.

U.S. Pat. No. 5,824,250 has disclosed the production of a ceramic shaped part-by means of a gel that contains ceramic. This process requires the use of a mold.

DE 198 53 834 A1 has disclosed a process for producing components by application technology. In this case, material has to be applied in layers. This is very time-consuming.

DE 199 48 591 A1 or WO 01/26885 A1 discloses a rapid prototyping process using a special application technology. The application technology involves the material which is to be applied being present in a support liquid.

U.S. Pat. No. 4,863,538, titled “Method and Apparatus for Producing Parts by Selective Sintering,” and U.S. Pat. No. 5,132,143, titled “Method for Producing Parts,” each discloses computer-aided laser apparatus for sequentially sintering a plurality of powder layers to build the desired part. Both of the foregoing patents are herein incorporated by reference in their entirety.

It is known from a publication issued by the Institute for Ceramic technologies and Sintered Materials entitled “Rapid Prototyping of Complex-Shaped Parts of Si/SiC Ceramics by Laser Sintering” to use CAD data to sinter ceramic components by means of laser. However, the ceramic components produced in this way are porous and have to be infiltrated with liquid silicon.

The contribution “Prototyping of Complex-Shaped Parts and Tools of Si/SiC Ceramics by Selective Laser Sintering” by Von W. Löschau, R. Lenk, Siegfried Scharek, M. Teichgräber, S. Nowotny, C. Richter, known from the 9th Simtec-World Ceramics Congress: Ceramics: Getting into the 2000s-Part B, likewise deals with the laser sintering of porous ceramic components.

It is known from the prior art to produce porous ceramics and to fill them with liquid silicon. This causes problems for high-temperature applications of a component of this type, since the silicon is vulnerable to re-melting during the use of the part.

### SUMMARY OF THE INVENTION

Standard rapid prototyping processes can be adapted to produce improved ceramic shaped objects. Inter alia, the selective laser sintering of ceramic powders may be useful in this context. In one exemplary embodiment, powder may be applied continuously or discontinuously, for example in a powder bed, and may be densified (e.g., sintered) by heat produced by laser energy directed at locations that correspond to the component to be produced.

Aspects of the present invention provide a method for rapidly producing a ceramic object having different material properties at selectable locations within the object. Laser energy may be used to sinter a ceramic powder. Bt way of example, powder particle size, powder particle composition, and laser energy parameters may be selectively varied across regions of the object. This may be useful for producing ceramic mold shells having a core portion and an envelope portion, wherein the desired properties of the core and envelope are different.

### BRIEF DESCRIPTION OF THE DRAWING

These and other advantages of the invention will be more apparent from the following description in view of the drawing that shows a ceramic mold shell formed by a process embodying aspects of the present invention.

### DETAILED DESCRIPTION OF THE INVENTION

According to aspects of the present invention, ceramic powders or powder mixtures with suitable grain sizes are used to produce a virtually dense shaped object using laser sintering, and further, to produce an object having a material property that may vary across regions of the object. In one exemplary embodiment, fine ceramic powders or powder mixtures with grain sizes typically less than 30 μm are used. The powder grain size may vary from one region of the object to another, such as by preparing a powder bed having at least two regions with at least two different powder mixtures. The powder mixture may also comprise one or more components that improve the densification/sintering by producing a liquid phase during the densification process (liquid-phase sintering).

A small residual porosity that may be present after laser sintering can be densified further by additional sintering or hot isostatic pressing. The geometry of the ceramic shaped object may be stored in a Computer-Aided Design (CAD) data set. A computer may be configured to control a laser system in response to the CAD data set for performing laser sintering of the powder bed in such a way that the geometry of the component is produced from a raw material powder bed.

The FIGURE shows a section through a ceramic mold shell 1 that is fabricated in accordance with aspects of the present invention. The ceramic mold shell 1 includes an outer envelope 4, which may be produced by means of a rapid prototyping process. The ceramic mold shell 1 may be used for a casting process, such as an investment casting process. Liquid metallic ceramic material may be cast into the cavity 10 formed by the outer envelope 4.

The ceramic mold shell 1 may also have a core 7 formed in its interior so that a hollow shaped body can be produced during a casting process. The core 7 may be mechanically joined to the outer envelope 4 by suitable affixing means, such as by a common base plate 6. The core 7 may comprise a different material than the outer envelope 4, and the envelope 4 may be layered or graded with different materials and/or different densities in various regions. In the case of selective laser sintering, the laser beam generated by the laser may, for example, be modulated to apply a greater or lower power to the regions in which the core 7 is formed, so that the desired densification condition for the material of the core 7 is created. It is also contemplated for the laser power to be locally varied, so that the outer envelope 4 has a high density in an inner region 13, where it is in contact with the molten material, and may have a lower density in an outer region 16. Other combinations of materials, densities and regions may be achieved for various embodiments.

It is also possible for the topmost surface region 15 of the inner region 13 to be formed as a porous layer that is, for example, approximately 1 mm thick while the remainder of region 13 is densely formed. This embodiment of a ceramic mold shell 1 may be used for casting a body that has a rough surface. Such a rough surface may be useful, for example, if coatings are applied to the casting, so that the coatings bond very successfully to the casting as a result of the rough surface.

Aspects of the present invention may be particularly useful when the outer envelope 4 is produced together with the core 7 in a manner that provides differing materials and/or densities between the core 7 and the envelope 4, such as by controlling the composition of the powder and the heat input provided by the laser in accordance with a desired control strategy. This considerably simplifies the production process when compared to prior art methods. The ceramic mold shell 1 can be densified still further by sintering or hot isostatic pressing after it has been produced by means of a rapid prototyping selective laser sintering process. Consequently, ceramic rapid prototype models may be used directly for a casting process and do not form a pattern, but rather a shaped cast that is fully useable. Larger mold shells can also be assembled as an integrated unit during a single fabrication process.

In one embodiment, a powder bed is prepared having a first powder mix in a first region and a second powder mix in a second region. The chemical compositions and/or powder particles size distributions may be varied between the two regions, for example a first mixture in a first region for forming the envelope 4 and a second mixture in a second region for forming the core 7. The powders preferably comprise ceramics but may comprise ceramic/alloy combinations. In one embodiment, silicon nitride and yttrium powders are combined to provide a degree of liquid phase sintering. A laser may be controlled in accordance with a stored program set to apply heat to the two regions, with the amount of heat at any given location varying between the two regions, and possibly even within one region, to achieve a desired degree of densification of the powders. The temperature necessary to achieve the desired densification in the first region may be different than the temperature necessary to achieve the desired densification in the second region, and the laser may be controlled accordingly as it is scanned across the powder bed. Additional layers of powder and additional steps of laser heating may be added to form a ceramic shape in accordance with the stored program. The shape is formed as a net shape or a near net shape, with little or no additional processing necessary before use. If desired, additional heating or material infusion may be provided after the selective laser sintering process forms the shape.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

1-16. (canceled)

17. A process for producing a ceramic shaped object from ceramic powder, comprising:
forming a first region of the shaped object by a first laser sintering of a first ceramic powder; and
forming a second region of the shaped object integral with the first region by a second laser sintering of a second ceramic powder,
wherein the forming of at least one of the first and second regions comprises controlling at least one parameter selected to provide a different material property in the first and second regions of the shaped object.

18. The process of claim 17, wherein a ceramic mold is formed.

19. The process of claim 17, wherein the material property is selected from the group consisting of: densification, porosity, surface roughness, and any combination thereof.

20. The process of claim 17, further comprising controlling a laser beam generated during the first and second laser sintering processes to produce a different sintering temperature over the first and second regions of the object creating a different degree of densification in the first and second regions of the shaped object.

21. The process of claim 18, further comprising at least one of an additional laser sintering process and a hot isostatic pressing of the ceramic mold to achieve any further densification.

22. The process of claim 17, further comprising accessing a computerized representation of the object and using the computerized representation to control the process for producing the ceramic shaped object.

23. The process of claim 18, further controlling the process to form the first region of the ceramic mold to comprise a shell and the second region of the ceramic mold to comprise a core disposed in a cavity of the shell.

24. The process of claim 18, wherein the first region of the ceramic mold comprises an inner region and the second region of the ceramic mold comprises an outer region and the process is controlled so that the inner region is denser than the outer region of the mold.

25. The process of claim 17, further comprising using a ceramic powder or a powder mixture comprising grain sizes of less than 30 μm for at least one of the regions of the object.

26. The process of claim 17, further comprising using a ceramic powder and a powder mixture comprising grain sizes of less than 30 μm for at least one of the regions of the object.

27. The process of claim 17, wherein the ceramic powder comprises at least one ingredient that affects densification and/or sintering of the ceramic powder by producing a liquid phase for at least one of the regions of the object.

28. The process of claim 18, wherein the process is controlled to provide a surface in an inner region of the ceramic mold comprising a surface roughness different from an outer region of the ceramic mold.

29. A mold for producing a ceramic shaped object, comprising:
a first region of the ceramic shaped object formed by a first sintering of a first ceramic powder;
a second region of the ceramic shaped object formed by a second sintering of a second ceramic powder and the second region is integral with the first region; and
a parameter selected and controlled to provide a different material property in the first and second regions of the shaped object.

30. The mold as claimed in claim 29, wherein the mold is a ceramic mold.

31. The mold as claimed in claim 29, wherein the first ceramic powder comprises a first material and the second ceramic powder comprises a second material different than the first material.

32. The mold as claimed in claim 29, wherein the first region comprises a first porosity and the second region comprises a second porosity different than the first porosity.

33. The mold as claimed in claim 29, wherein the first region comprises a first density and the second region comprises a second density different than the first density.

34. The mold as claimed in claim 29, wherein the first region comprises a first surface roughness and the second region comprises a second surface roughness different than the first surface roughness.

35. The mold as claimed in claim 29, wherein the first ceramic powder comprises a first average grain size and the second ceramic powder comprises a second average grain size.
